(19) United States
(12) Patent Application Publication
(10) Pub. No.: US 2019/0346607 A1
(43) Pub. Date: Nov. 14, 2019

(54) RETARDATION SUBSTRATE, LIQUID CRYSTAL ELEMENT AND LIQUID CRYSTAL MODULE

(71) Applicant: SHARP KABUSHIKI KAISHA, Sakai City, Osaka (JP)

(72) Inventors: KOJI MURATA, Sakai City (JP); AKIRA SAKAI, Sakai City (JP); YUICHI KAWAHIRA, Sakai City (JP); KOZO NAKAMURA, Sakai City (JP); MASAHIRO HASEGAWA, Sakai City (JP); TAKAKO KOIDE, Sakai City (JP); KIYOSHI MINOURA, Sakai City (JP)

(21) Appl. No.: 16/307,445

(22) PCT Filed: May 30, 2017
(86) PCT No.: PCT/JP2017/020069

§ 371 Date: Dec. 5, 2018

(30) Foreign Application Priority Data
Jun. 6, 2016 (JP) 2016-112635

(51) Int. Cl. G02B 5/30

(52) U.S. Cl. CPC G02B 5/3025; G02F 1/13363; G02B 5/3008

(57) ABSTRACT

The present invention provides a retardation substrate which less dissolves a retardation layer, shows good depolarization performance, and has a high voltage holding ratio when used for a liquid crystal element, and a liquid crystal element and a liquid crystal module which include the retardation substrate. The retardation substrate includes: a base material; a retardation layer provided on one surface of the base material; a dielectric layer provided on a surface, opposite to the base material, of the retardation layer; and an alignment film which is provided on a surface, opposite to the retardation layer, of the dielectric layer and subjected to a liquid crystal alignment treatment.

### TECHNICAL FIELD

The present invention relates to a retardation substrate, a liquid crystal element, and a liquid crystal module. More specifically, the present invention relates to a retardation substrate subjected to a liquid crystal alignment treatment, a liquid crystal element including the retardation substrate, and a liquid crystal module.

### BACKGROUND ART

A liquid crystal display device is a display device that uses a liquid crystal composition for display. As a representative display method therefor, a liquid crystal display panel in which a liquid crystal composition is sealed between a pair of substrates is irradiated with light from a backlight, and the alignment of the liquid crystal molecules is changed by application of a voltage to the liquid crystal composition, thereby controlling the amount of light passing through the liquid crystal display panel. Since such a liquid crystal display device has characteristics such as thinness, light weight, and low power consumption, the device is used in electronic devices such as television, smartphone, tablet PC, and car navigation.

In the case of using the conventional liquid crystal display device outdoors, the reflection of external light on the inside and on the surface of the liquid crystal display device becomes large, whereby the visibility may deteriorate (the contrast is lowered, and discoloration may occur). As a technique for improving outdoor visibility, for example, Patent Literature 1 discloses an in-plane switching (IPS) liquid crystal panel in which, in a liquid crystal panel used by allowing a backlight unit to emit light from the back side, a first retarder is provided between a first polarizing plate arranged on the front side of the liquid crystal panel and a liquid crystal layer, at least one retarder is provided between a second polarizing plate arranged on the back side of the liquid crystal panel and a liquid crystal layer, and the first retarder and the at least one retarder satisfy a specific condition, so that good image quality can be obtained even during outdoor use. Further, Non-Patent Literature 1 discloses that a transflective IPS mode liquid crystal display using a patterned in-cell retarder can improve outdoor visibility.

### CITATION LIST

### Patent Literature

Patent Literature 1: JP 2012-173672 A

### Non-Patent Literature

Non-Patent Literature 1: Imayama et al., “Novel Pixel Design for a Transflective IPS-LCD with an In-Cell Retarder”, SID 07 DIGEST, 2007, pp. 1651-1654

### SUMMARY OF INVENTION

### Technical Problem

However, in the inventions described in Patent Literature 1 and Non-Patent Literature 1, when a retarder is arranged between a substrate and a liquid crystal layer, in the process of forming an alignment film on the retarder, a solvent for forming an alignment film often dissolves the retarder, and thus it is difficult to form the alignment film. Further, in some cases, the retarder is dissolved in the solvent for forming the alignment film and deteriorated, whereby the depolarization performance of the retarder is likely to deteriorate, and the performance of the liquid crystal display device becomes unstable. Furthermore, in some cases, the solvent for forming the alignment film dissolves the retarder, whereby the components of the retarder and the color filter layer dissolve into the liquid crystal layer, and a voltage holding ratio (VHR) is decreased.

In view of the above state of the art, it is an object of the present invention to provide a retardation substrate which less dissolves a retardation layer, shows good depolarization performance, and has a high voltage holding ratio when used for liquid crystal element, and a liquid crystal element and a liquid crystal module which include the retardation substrate.

### Solution to Problem

The present inventors have made various investigations concerning a retardation substrate which less dissolves a retardation layer, shows good depolarization performance, and has a high voltage holding ratio when used for liquid crystal element in the case of arranging the retardation layer on the side of the liquid crystal layer of the base material. Then, they have found that the dissolution of the retardation layer can be suppressed by providing a dielectric layer on the surface, opposite to the base material, of the retardation layer. As a result, they have conceived that the above problems can be solved satisfactorily and these findings have now led to completion of the present invention.

That is, one aspect of the present invention may be a retardation substrate including: a base material; a retardation layer provided on one surface of the base material; a dielectric layer provided on a surface, opposite to the base material, of the retardation layer; and an alignment film which is provided on a surface, opposite to the retardation layer, of the dielectric layer and subjected to a liquid crystal alignment treatment.

Another aspect of the present invention may be a retardation substrate including: a base material; a retardation layer provided on one surface of the base material; and a dielectric layer which is provided on a surface, opposite to the base material, of the retardation layer and subjected to a liquid crystal alignment treatment.

The retardation layer may be made of a photo-alignment material including a photo-reactive functional group.

The retardation layer may contain a liquid crystalline polymer.

The retardation layer may have a retardation of λ/4.

The dielectric layer may be an inorganic film.

The inorganic film may contain at least one selected from SiO₂ and SiN.

The liquid crystal alignment treatment may be a rubbing alignment treatment.

The liquid crystal element may include the retardation substrate; a different base material; a liquid crystal layer provided between the retardation substrate and the different base material; and an electric field generator which generates an electric field in the liquid crystal layer.

The electric field generator may include a pair of electrodes, the pair of electrodes may be provided on the different base material, and a lateral electric field may be generated in the liquid crystal layer by application of a voltage between the pair of electrodes.

The liquid crystal layer may contain liquid crystal molecules having positive anisotropy of dielectric constant.

The liquid crystal layer may further include a color filter layer.

The liquid crystal layer may further include a pair of polarizing plates arranged in a crossed Nicols state.

The liquid crystal module may include the liquid crystal element and a light source which irradiates the liquid crystal element with light.

### Advantageous Effects of Invention

The present invention can provide a retardation substrate which less dissolves a retardation layer, shows good depolarization performance, and has a high voltage holding ratio when used for liquid crystal element, and a liquid crystal element and a liquid crystal module which include the retardation substrate.

### BRIEF DESCRIPTION OF DRAWINGS

FIG. 1 is a schematic cross-sectional view illustrating a retardation substrate of Embodiment 1.

FIG. 2 is a schematic cross-sectional view illustrating a retardation substrate of Embodiment 2.

FIGS. 3(a) and 3(b) are schematic views concerning a liquid crystal element of Embodiment 3, where FIG. 3(a) is a schematic cross-sectional view illustrating a liquid crystal element, and FIG. 3(b) is a schematic cross-sectional view illustrating a configuration example of a second substrate.

FIG. 4 is a schematic cross-sectional view illustrating a liquid crystal module of Embodiment 4.

FIGS. 5(a) to 5(d) are views illustrating each step of producing a first substrate in Example 1, where FIG. 5(a) is a schematic cross-sectional view illustrating a state in which a color filter layer is provided on a base material, FIG. 5(b) is a schematic cross-sectional view illustrating a state in which a first retardation layer is provided on the color filter layer, FIG. 5(c) is a schematic cross-sectional view illustrating a state in which a dielectric layer is provided on the first retardation layer, and FIG. 5(d) is a schematic cross-sectional view illustrating a state in which a first alignment film is provided on the dielectric layer.

FIGS. 6(a) and 6(b) are views illustrating each step of producing a second substrate in Example 1, where FIG. 6(a) is a schematic cross-sectional view illustrating a state in which an electrode is provided on a base material, and FIG. 6(b) is a schematic cross-sectional view illustrating a state in which a second alignment film is provided on the electrode.

FIGS. 7(a) and 7(b) are views illustrating a state of an electrode on a second substrate, where FIG. 7 (a) is a schematic cross-sectional view of the electrode, and FIG. 7(b) is a schematic plan view of the electrode.

FIG. 8 is a schematic cross-sectional view illustrating a state of producing a liquid crystal element in Example 1.

FIGS. 9(a) and 9(b) are views illustrating an alignment state of negative liquid crystal molecules of Example 1, where FIG. 9(a) is a schematic plan view illustrating a state of liquid crystal molecules in a no-voltage applied state, and FIG. 9(b) is a schematic plan view illustrating a state of liquid crystal molecules in a voltage-applied state.

FIG. 10 is a schematic cross-sectional view of a liquid crystal module of Example 1 and a diagram illustrating a polarization state.

FIG. 11 is a schematic cross-sectional view of a liquid crystal element in a case where a conductive layer is used instead of a dielectric layer in the liquid crystal module of Example 1.

FIG. 12 is a graph illustrating a relationship between driving voltage and transmittance, where a broken line is a graph concerning the liquid crystal module using the conductive layer, and a solid line is a graph concerning the liquid crystal module of Example 1 in which no conductive layer is used.

FIG. 13 is a schematic cross-sectional view illustrating a state of producing a liquid crystal module of Example 2.

FIGS. 14(a) and 14 (b) are views illustrating an alignment state of positive liquid crystal molecules of Example 3, where FIG. 14(a) is a schematic plan view illustrating a state of liquid crystal molecules in a no-voltage applied state, and FIG. 14(b) is a schematic plan view illustrating a state of liquid crystal molecules in a voltage-applied state.

FIGS. 15(a) and 15(b) are views illustrating a state of liquid crystal molecules in a voltage-applied state, where FIG. 15(a) is a schematic cross-sectional view in a case where the conductive layer is used, and FIG. 15(b) is a schematic cross-sectional view in a case where the dielectric layer is used.

FIG. 16 is a graph illustrating a relationship between time and transmittance, where a broken line is a graph concerning negative liquid crystal molecules, and a solid line is a graph concerning positive liquid crystal molecules.

### DESCRIPTION OF EMBODIMENTS

The present invention will be described in more detail based on embodiments with reference to the drawings. The embodiments, however, are not intended to limit the scope of the present invention. Further, the configurations of the embodiments may appropriately be combined or modified within the spirit of the present invention.

The term “polarizing plate” without “linearly” refers to a linearly polarizing plate, and is distinguished from a circularly polarizing plate.

The term “λ/4 plate” used herein refers to a retarder that gives an in-plane retardation of a quarter of a wavelength (strictly speaking, 137.5 nm) to light having at least a wavelength of 550 nm, and may be a retarder that gives an in-plane retardation of 100 nm or more and 176 nm or less. Incidentally, the light having a wavelength of 550 nm is light having a wavelength with the highest human visibility.

In this specification, nx and ny refer to main refractive indexes in the in-plane direction of the retarder (including the λ/4 plate), and nz refers to a main refractive index in the thickness direction of the retarder. Unless otherwise specified, the term “main refractive index” refers to a value for light having a wavelength of 550 nm. When the larger one of nx and ny is defined as ns and the smaller one is defined as nf, the in-plane slow axis refers to an axis in the direction corresponding to ns, and the in-plane fast axis refers to an axis in the direction corresponding to nf.

In this specification, the fact that the two axes (directions) are perpendicular means that the angle (absolute value) between the two axes is within the range of 90±3°, preferably within the range of 90±1°, more preferably within the range of 90±0.5°, and particularly preferably 90° (completely perpendicular). The fact that the two axes (directions) are parallel means that the angle (absolute value) between the two axes is within the range of 0±3°, preferably within the range of 0±1°, more preferably within the range of 0±0.5°, and particularly preferably 0° (completely parallel). The fact that the two axes (directions) form an angle of 45° means that the angle (absolute value) between the two axes is within the range of 45±3°, preferably within the range of 45±1°, more preferably within the range of 45±0.5°, and particularly preferably 45° (completely 45°).

### Embodiment 1

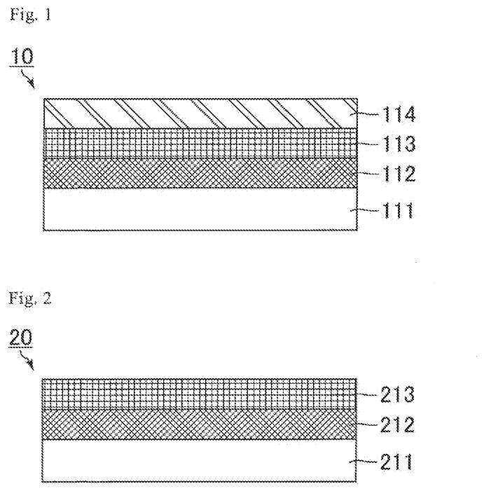

FIG. 1 is a schematic cross-sectional view illustrating a retardation substrate of Embodiment 1. As illustrated in FIG. 1, a retardation substrate 10 of Embodiment 1 includes: a base material 111; a retardation layer 112 provided on one surface of the base material 111; a dielectric layer 113 provided on a surface, opposite to the base material 111, of the retardation layer 112; and an alignment film 114 which is provided on a surface, opposite to the retardation layer 112, of the dielectric layer 113 and subjected to a liquid crystal alignment treatment. Note that another layer such as a color filter layer may be provided between the layers.

Normally, a mixed solvent containing, for example, γ-butyrolactone, N-methylpyrrolidone (NMP), and butyl cellosolve is used for the solvent for applying the alignment film, for the purpose of viscosity adjustment and wettability improvement. Therefore, in the configuration of the conventional retardation substrate in which the dielectric layer is not arranged, the mixed solvent often dissolves the retardation layer when the alignment film is applied to the retardation layer. Thus, it is difficult to form the alignment film. However, in this embodiment, the dielectric layer 113 is present between the retardation layer 112 and the alignment film 114 so that the solvent used for forming the alignment film 114 can be prevented from dissolving the retardation layer 112.

The base material 111 is preferably a transparent base material having transparency, and examples thereof include a glass base material and a plastic base material.

The retardation layer 112 is a layer that changes the state of incident polarized light by giving retardation to two perpendicular polarization components using a birefringent material or the like. For example, the layer is made of a photo-alignment material including a photo-reactive functional group.

The term “photo-alignment material including a photo-reactive functional group” refers to a material that improves the alignment properties of the photo-reactive functional group by the following method. First, the photo-alignment material including a photo-reactive functional group is applied to a base material to form a photo-alignment material film. Then, the photo-alignment material film is pre-baked. Next, the photo-alignment material film after the pre-baking is irradiated with light (e.g., irradiated with polarized ultraviolet light), thereby causing a chemical reaction of the photo-reactive functional group (at least one chemical reaction selected from the group consisting of photodimerization, photoisomerization, and photo Fries rearrangement). Finally, the photo-alignment material film irradiated with light is subjected to post-baking at a temperature higher than the pre-baking temperature, whereby the chemical reaction caused by irradiation with light triggers an improvement in the alignment properties of the photo-reactive functional group.

The photo-alignment material including a photo-reactive functional group has a sufficient film thickness and birefringence, so that a retardation corresponding to λ/4 can be exhibited. The use of the photo-alignment material allows for the production of the retardation layer 112 having liquid crystal alignment properties in a single layer. Thus, in a liquid crystal display device having the retardation layer 112 of this embodiment, the parallax mixed color can be expected to be suppressed.

Examples of the photo-reactive functional group capable of photodimerization and photoisomerization include a cinnamate group, a chalcone group, a coumarin group, and a stilbene group.

Examples of the photo-reactive functional group capable of photoisomerization include an azobenzene group.

Examples of the photo-reactive functional group capable of photo Fries rearrangement include a phenol ester group.

Examples of the main skeleton of the photo-alignment material (solids content) include structures such as polyamic acid, polyimide, acryl, methacryl, maleimide, and polysiloxane.

Further, the retardation layer 112 may contain a liquid crystalline polymer. The liquid crystalline polymer is, for example, a uniaxial liquid crystal (e.g., a nematic liquid crystal), and one capable of easily fixing its alignment state is preferably used. The liquid crystalline polymer is formed by polymerizing a liquid crystalline monomer including a photo-reactive functional group (including a polymerization initiator) by irradiation with polarized ultraviolet light. The liquid crystalline polymer has a sufficient film thickness and birefringence, so that a retardation corresponding to λ/4 can be exhibited. The use of the liquid crystalline polymer allows for the production of the retardation layer 112 having liquid crystal alignment properties in a single layer. Thus, in a liquid crystal display device having the retardation layer 112 of this embodiment, the parallax mixed color can be expected to be suppressed.

The retardation layer 112 is preferably a λ/4 plate, and more preferably a λ/4 plate (positive A plate) whose main refractive indexes satisfy the relationship of nx>ny=nz. The λ/4 plate is used as the retardation layer 112, so that the reflection of external light in the liquid crystal display device using the retardation substrate 10 can be further suppressed.

The thickness of the retardation layer 112 is preferably 1.0 μm to 3.0 μm, and more preferably 1.2 μm to 2.0 μm.

The dielectric layer 113 is a layer including a dielectric and preferably has transparency. Since the dielectric layer 113 is provided between the retardation layer 112 and the alignment film 114, the solvent used for forming the alignment film 114 can be prevented from dissolving the retardation layer 112. Thus, the alignment film 114 can be easily formed. Further, since the dielectric layer 113 is provided, deterioration of the retardation layer 112 due to dissolution can be suppressed. Thus, the depolarization performance of the retardation substrate 10 can be maintained at a high level. Note that the term “depolarization performance” means the degree to which the polarized light is destroyed, and the term “high depolarization performance” means that the polarized light is hardly destroyed. Further, the components of the retardation layer 112 and the color filter layer can be prevented from being dissolved in the liquid crystal layer. Thus, a high voltage holding ratio can be realized when the retardation substrate 10 is used for the liquid crystal element.

As the dielectric layer 113, either an inorganic film or an organic film can be used. As the inorganic film, a material such as silicon oxide (SiO₂) or silicon nitride (SiNx) can be used. As the organic film, a material such as a photosensitive acrylic resin can be used. The dielectric layer 113 is preferably an inorganic film since the dielectric layer 113 is easily formed by a dry process. Among inorganic films, SiO₂ and SiNx are preferable because of high degree of transparency and high denseness.

The relative dielectric constant ε of the dielectric layer 113 is preferably 1.0<ε<9.0, and more preferably 3.0<ε<7.5. The relative dielectric constant of air is 1.00059, the relative dielectric constant of SiO₂ is 3.5, the relative dielectric constant of SiN is 7.0, and the relative dielectric constant of ITO is 9.0.

The dielectric layer 113 can be formed using, for example, a sputtering method, an evaporation method, or a plasma chemical vapor deposition (CVD) method.

The thickness of the dielectric layer 113 is preferably 50 nm to 1000 nm, more preferably 80 nm to 500 nm, and still more preferably 100 nm to 300 nm.

The alignment film 114 has a function of controlling the alignment of the liquid crystal molecules in the liquid crystal layer described later. When the voltage applied to the liquid crystal layer is less than the threshold voltage (including no voltage application), the alignment of the liquid crystal molecules in the liquid crystal layer is controlled mainly by the actions of the alignment film 114 and the second alignment film described later. The alignment film 114 is a layer subjected to an alignment treatment for controlling the alignment of liquid crystal molecules. Examples of the alignment treatment include a rubbing alignment treatment for performing alignment treatment by rubbing the surface of the layer with a roller or the like, and a photo-alignment treatment for performing alignment treatment by irradiating with light. The alignment film 114 is preferably subjected to the rubbing alignment treatment. The reason is that the alignment film has a relatively high alignment regulation force of liquid crystal molecules and also has been used as a time-proven alignment film for a long time.

The thickness of the alignment film 114 is preferably 50 nm to 200 nm, and more preferably 80 nm to 120 nm.

### Embodiment 2

The retardation substrate of Embodiment 2 has the same configuration as the retardation substrate 10 of Embodiment 1 except that the alignment film is not used. In this embodiment, characteristics peculiar to this embodiment will mainly be described, and the description overlapping with Embodiment 1 will be omitted as appropriate.

FIG. 2 is a schematic cross-sectional view illustrating a retardation substrate of Embodiment 2. As illustrated in FIG. 2, the retardation substrate 20 includes a base material 211, a retardation layer 212 provided on one surface of the base material 211, and a dielectric layer 213 which is provided on a surface, opposite to the base material 211, of the retardation layer 212 and subjected to a liquid crystal alignment treatment. Note that another layer such as a color filter layer may be provided between the layers.

The retardation substrate 20 of Embodiment 2 has no alignment film, and the dielectric layer 213 is subjected to an alignment treatment such as a rubbing treatment in order to align the liquid crystal molecules. That is, the alignment film is not formed on the dielectric layer 213, and the dielectric layer 213 is directly subjected to the rubbing treatment. Accordingly, the liquid crystal molecules can be aligned in the rubbing direction, so that the liquid crystal element using the retardation substrate 20 of Embodiment 2 can perform the same operation as the liquid crystal element using the retardation substrate 10 of Embodiment 1.

In the retardation substrate 20 of Embodiment 2, since the alignment treatment is directly performed on the dielectric layer 213, the alignment film may not be used. This eliminates the problem that the solvent used for forming the alignment film dissolves the retardation layer 212. This makes it possible to provide a retardation substrate showing good depolarization performance and having a high voltage holding ratio when used for the liquid crystal element. Further, the production process for forming the alignment film can be omitted, and this leads to simplification of the production process and cost reduction.

### Embodiment 3

The liquid crystal element of Embodiment 3 is a liquid crystal element in which various members such as a color filter and electrodes are arranged on the retardation substrate 10 of Embodiment 1 as described above. In this embodiment, characteristics peculiar to this embodiment will mainly be described, and the description overlapping with Embodiment 1 will be omitted as appropriate. Although the retardation substrate 10 of Embodiment 1 is used in this embodiment, the retardation substrate 20 of Embodiment 2 can be used instead of the retardation substrate 10 of Embodiment 1. In addition, the first base material and the second base material in the following embodiments and examples correspond to the base material and the different base material in each of the embodiments of the present invention, respectively. The first retardation layer corresponds to the retardation layer in the aspect of the present invention, the first alignment film corresponds to the alignment film in the embodiment of the present invention, and the first substrate corresponds to the retardation substrate in the aspect of the present invention.

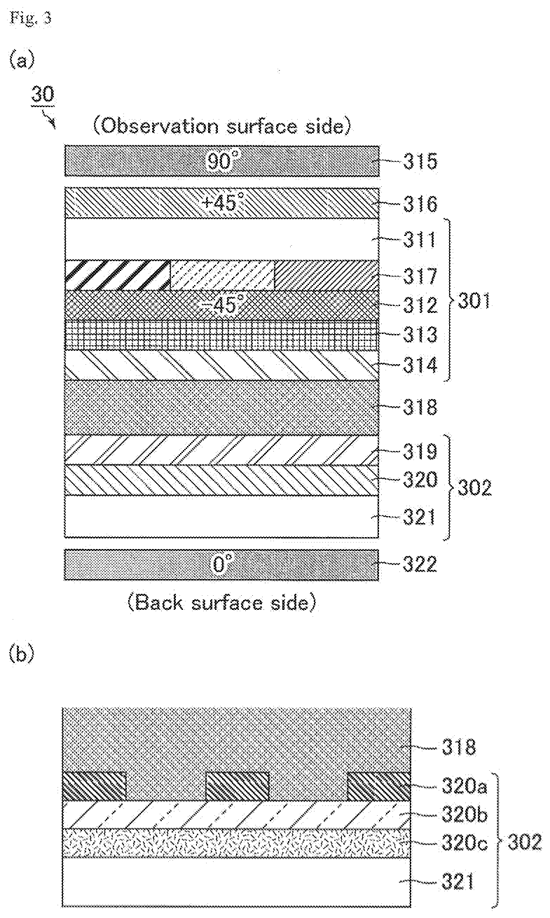

FIGS. 3(a) and 3(b) are schematic views concerning a liquid crystal element of Embodiment 3, where FIG. 3(a) is a schematic cross-sectional view illustrating a liquid crystal element, and FIG. 3(b) is a schematic cross-sectional view illustrating a configuration example of a second substrate.

As illustrated in FIG. 3 (a), a liquid crystal element 30 includes a first polarizer 315, a second retardation layer 316, a first substrate 301, a liquid crystal layer 318, a second substrate 302, and a second polarizer 322, in this order from the observation surface side.

The first substrate 301 has a first base material 311, a color filter layer 317, a first retardation layer 312, a dielectric layer 313, and a first alignment film 314, in this order from the observation surface side. That is, the first substrate 301 is a substrate in which a color filter layer is provided between the base material 111 and the retardation layer 112 in the retardation substrate 10 of Embodiment 1.

The second substrate 302 has a second alignment film 319, an electrode 320, and a second base material 321, in this order from the observation surface side to the back surface side. As the electrode 320, the second substrate 302 has a pair of electrodes which generates a lateral electric field in the liquid crystal layer 318 by application of a voltage.

In the liquid crystal element 30 of Embodiment 3, the first substrate 301 having the dielectric layer 313 is arranged adjacent to the liquid crystal layer 318, so that the dielectric layer 313 can prevent the ionic impurities in the first substrate 301 from leaking into the liquid crystal layer 318. As a result, the liquid crystal element 30 can realize a high voltage holding ratio (VHR).

Further, in the liquid crystal element 30 of Embodiment 3, the dielectric layer 313 is used instead of the conductive layer, so that the threshold value of the driving voltage can be lowered and the width of the reduction in the transmittance can be reduced.

As the first polarizer 315 and the second polarizer 322, for example, a polarizer (absorption polarizer) obtained by staining and adsorbing a polyvinyl alcohol (PVA) film with an anisotropic material such as an iodine complex (or dye), and stretching and aligning the resultant film can be used. Note that each of the polarizers 315 and 322 may be referred to as “polarizing plate”.

The transmission axis of the first polarizer 315 is preferably perpendicular to the transmission axis of the second polarizer 322. According to such a configuration, the first polarizer 315 and the second polarizer 322 are arranged in a crossed Nicols state, so that a black display state can be preferably realized when no voltage is applied.

The second retardation layer 316 is a layer that changes the state of incident polarized light by giving retardation to two perpendicular polarization components using a birefringent material or the like. For example, the layer is made of a liquid crystal polymer or a photo-alignment material including a photo-reactive functional group. The second retardation layer 316 preferably contains a liquid crystalline polymer. As the liquid crystalline polymer and the photo-alignment material including a photo-reactive functional group, the same materials as those described in the retardation layer 112 of Embodiment 1 can be used.

The second retardation layer 316 is preferably a λ/4 plate, and more preferably a λ/4 plate (negative A plate) whose main refractive indexes satisfy the relationship of nx<ny=nz.

The thickness of the second retardation layer 316 is preferably 1.0 μm to 3.0 μm, and more preferably 1.2 μm to 2.0 μm.

As the color filter layer 317 of the first substrate 301, either a pigment color material or a dye color material can be used. The combination of colors is not particularly limited, and examples thereof include a combination of red, green and blue, and a combination of red, green, blue, and yellow. Preferably, a pigment color resist is used for the color filter layer 317.

The liquid crystal layer 318 contains a liquid crystal composition. A voltage is applied to the liquid crystal layer 318, and the alignment state of the liquid crystal molecules in the liquid crystal composition is changed according to the applied voltage, thereby controlling the light transmission amount.

The liquid crystal molecules may have negative anisotropy of dielectric constant (As) defined by the following formula, or may have positive anisotropy of dielectric constant. Note that the liquid crystal molecules having positive anisotropy of dielectric constant are also referred to as “positive liquid crystals”, and the liquid crystal molecules having negative anisotropy of dielectric constant are also referred to as “negative liquid crystals”.

Δε=(dielectric constant in the major axis direction)−(dielectric constant in the minor axis direction)

The liquid crystal molecules having positive anisotropy of dielectric constant can be preferably used because the liquid crystal molecules can increase the response speed. Further, the liquid crystal molecules having negative anisotropy of dielectric constant are preferably used, because even when the electric field application is disturbed, the alignment state of liquid crystal molecules is unlikely to be disturbed or light scattering is less likely to occur as compared with the liquid crystal molecules having positive anisotropy of dielectric constant (because the transmittance is improved).

The second alignment film 319 has a function of controlling the alignment of liquid crystal molecules in the liquid crystal layer 318. When the voltage applied to the liquid crystal layer 318 is less than the threshold voltage (including no voltage application), the alignment of the liquid crystal molecules in the liquid crystal layer 318 is controlled mainly by the actions of the first alignment film 314 and the second alignment film 319. The second alignment film 319 is a layer subjected to an alignment treatment for controlling the alignment of liquid crystal molecules, and examples of the alignment treatment include a rubbing alignment treatment and a photo-alignment treatment. The second alignment film 319 is preferably subjected to the rubbing alignment treatment.

The thickness of the second alignment film 319 is preferably 50 nm to 200 nm, and more preferably 80 nm to 120 nm.

Here, the configuration of the second substrate 302 will be described in detail. As illustrated in FIG. 3 (b), the second substrate 302 is a thin-film transistor array substrate in an FFS mode, and has: the second base material 321, a pixel electrode (a planar electrode, one of a pair of electrodes) 320c arranged on the surface on the side of the liquid crystal layer 318 of the second base material 321, an insulating film 320b covering the pixel electrode 320c, a common electrode (a comb-tooth electrode, the other of the pair of electrodes) 320a arranged on the surface on the side of the liquid crystal layer 318 of the insulating film 320b, and the second alignment film 319 (not illustrated). According to such a configuration, a lateral electric field (a fringe electric field) is generated in the liquid crystal layer 318 by application of a voltage to the pixel electrode 320c and the common electrode 320a (during application of a voltage), so that the alignment of the liquid crystal molecules in the liquid crystal layer 318 can be controlled.

The second base material 321 is preferably a transparent base material having transparency, and examples thereof include a glass base material and a plastic base material.

The electrode 320 includes the pixel electrode 320c and the common electrode 320a. Examples of the material of the pixel electrode 320c and the common electrode 320a include indium tin oxide (ITO) and indium zinc oxide (IZO).

Examples of the material of the insulating film 320b include an organic insulating film and a nitride film.

In this embodiment, although the first substrate 301 is the color filter substrate and the second substrate 302 is the thin-film transistor array substrate, the first substrate 301 may be used as the thin-film transistor array substrate and the second substrate 302 may be used as the color filter substrate.

Then, the relationship between the in-plane slow axes of the first retardation layer 312 and the second retardation layer 316 and the transmission axes of the first polarizer 315 and the second polarizer 322 will be described below.

When the second retardation layer 316 is a λ/4 plate, the in-plane slow axis of the second retardation layer 316 and the transmission axis of the first polarizer 315 may preferably form an angle of 45°. Such a configuration realizes a configuration in which a circularly polarizing plate formed by stacking the first polarizer 315 and the second retardation layer 316 as the λ/4 plate is arranged on the observation surface side of the liquid crystal element 30. Therefore, the light incident from the observation surface side of the liquid crystal element 30 (side of the first polarizer 315) is converted into circularly polarized light when passing through the circularly polarizing plate, and reaches the first substrate 301, whereby the reflection from the first substrate 301 is suppressed by the antireflection effect of the circularly polarizing plate. When the circularly polarizing plate is formed by stacking the first polarizer 315 and the second retardation layer 316 as the λ/4 plate, a roll-to-roll system is preferably used from the viewpoint of enhancing production efficiency.

In the case where the first retardation layer 312 and the second retardation layer 316 are λ/4 plates, when the second polarizer 322 has a transmission axis of 0°, preferably, the in-plane slow axis of the first retardation layer 312 is −45°, the in-plane slow axis of the second retardation layer 316 is 45°, and the transmission axis of the first polarizer 315 is 90°. In this case, the in-plane slow axis of the first retardation layer 312 as the λ/4 plate is perpendicular to the in-plane slow axis of the second retardation layer 316 as the λ/4 plate. Such a configuration can cancel the retardation between the first retardation layer 312 and the second retardation layer 316 with respect to the light incident on the liquid crystal element 30 from at least the normal direction. Optically, a state in which both the layers are substantially absent is realized. That is, a configuration is realized in which the light incident on the liquid crystal element 30 (light incident on the liquid crystal element 30 from at least the normal direction) is optically equivalent to the conventional liquid crystal display panel in a lateral electric field mode. Therefore, a display in the lateral electric field mode using the circularly polarizing plate can be realized. Here, the first retardation layer 312 and the second retardation layer 316 are preferably made of the same material. Thereby, the first retardation layer 312 and the second retardation layer 316 can cancel the retardation including the wavelength dispersion.

### Embodiment 4

The liquid crystal module of Embodiment 4 was produced by arranging a backlight in the liquid crystal element of Embodiment 3 described above. In this embodiment, characteristics peculiar to this embodiment will mainly be described, and the description overlapping with Embodiment 3 will be omitted as appropriate. Although the retardation substrate 10 of Embodiment 1 is used in this embodiment, the retardation substrate 20 of Embodiment 2 can be used instead of the retardation substrate 10 of Embodiment 1.

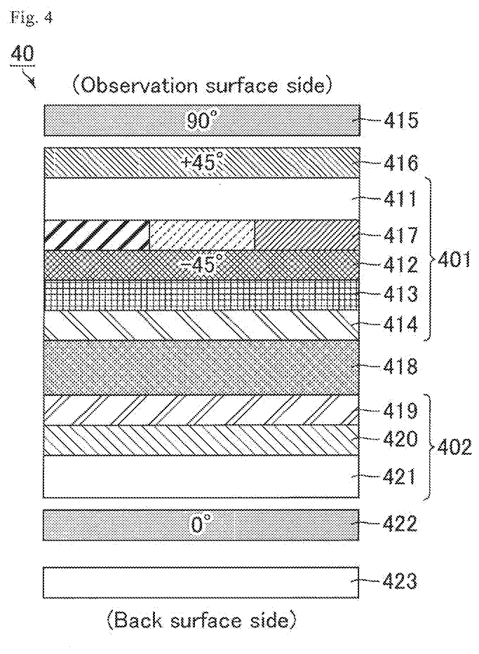

FIG. 4 is a schematic cross-sectional view illustrating a liquid crystal module of Embodiment 4. As illustrated in FIG. 4, a liquid crystal module 40 includes a first polarizer 415, a second retardation layer 416, a first substrate 401, a liquid crystal layer 418, a second substrate 402, and a second polarizer 422, and a backlight 423, in this order from the observation surface side. The first substrate 401 has a first base material 411, a color filter layer 417, a first retardation layer 412, a dielectric layer 413, and a first alignment film 414, in this order from the observation surface side. That is, the first substrate 401 is a substrate in which a color filter layer is provided between the base material 111 and the retardation layer 112 in the retardation substrate 10 of Embodiment 1. Note that each of the polarizers 415 and 422 may be referred to as “polarizing plate”.

The second substrate 402 has a second alignment film 419, an electrode 420, and a second base material 421, in this order from the observation surface side.

In this manner, the liquid crystal module 40 of Embodiment 4 has a configuration including the backlight 423 on the back surface side of the liquid crystal element 30 of Embodiment 3.

The type of the backlight 423 is not particularly limited, and examples thereof include an edge-lit backlight and a direct-lit backlight. The type of the light source of the backlight 423 is not particularly limited, and examples thereof include a light-emitting diode (LED) a cold cathode fluorescent lamp (CCFL).

In the case where the first retardation layer 412 and the second retardation layer 416 are λ/4 plates, when the second polarizer 422 has a transmission axis of 0°, preferably, the in-plane slow axis of the first retardation layer 412 is −45°, the in-plane slow axis of the second retardation layer 416 is 45°, and the transmission axis of the first polarizer 415 is 90°. In this case, the in-plane slow axis of the first retardation layer 412 as the λ/4 plate is perpendicular to the in-plane slow axis of the second retardation layer 416 as the λ/4 plate. According to such a configuration, the light from the backlight 423 can be emitted as linearly polarized light.

Hereinafter, the present invention will be described in more detail with reference to examples. However, the present invention is not limited by these examples.

### Example 1

### <Production of First Substrate Having Color Filter Layer>

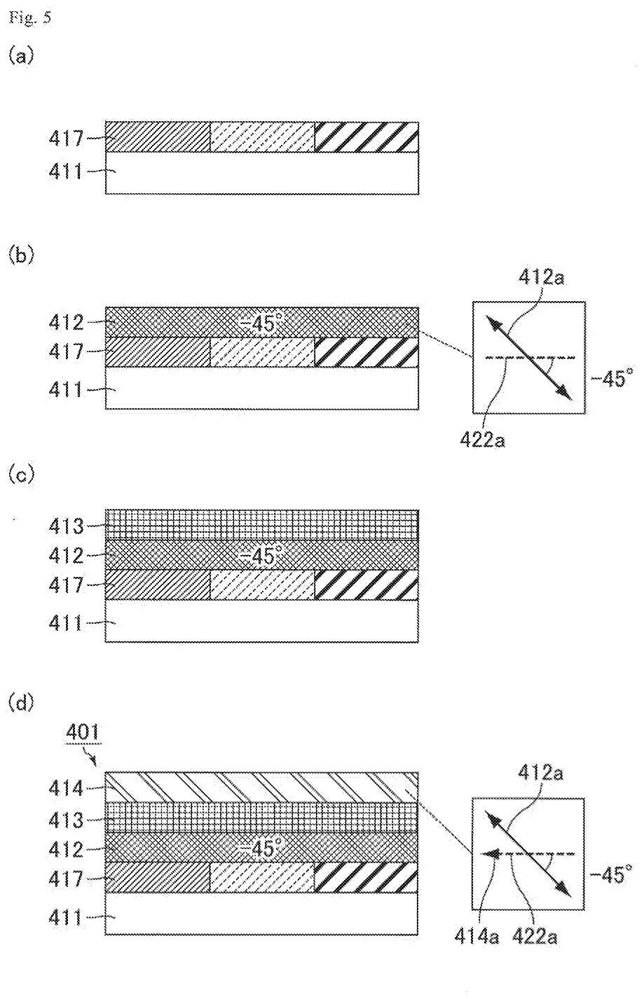

FIGS. 5(a) to 5(d) are views illustrating each step of producing a first substrate in Example 1, where FIG. 5(a) is a schematic cross-sectional view illustrating a state in which a color filter layer is provided on a base material, FIG. 5 (b) is a schematic cross-sectional view illustrating a state in which a first retardation layer is provided on the color filter layer, FIG. 5(c) is a schematic cross-sectional view illustrating a state in which a dielectric layer is provided on the first retardation layer, and FIG. 5(d) is a schematic cross-sectional view illustrating a state in which a first alignment film is provided on the dielectric layer.

The color filter layer 417 was provided on the first base material 411 (thickness of 0.7 mm) as the transparent base material, followed by washing with ultrasonic wave and washing with pure water to form a laminate illustrated in FIG. 5(a).

Subsequently, a photo-alignment material including a photo-reactive functional group, derived from an acrylic monomer, was applied to the color filter layer 417 at 500 rpm for 12 seconds by a spin coating method to form the first retardation layer 412. Thereafter, the formed layer was pre-baked at 60° C. for 5 minutes and irradiated with polarized ultraviolet light of 100 mJ so that the in-plane slow axis 412a of the first retardation layer 412 was −45° (45° clockwise) with respect to the transmission axis 422a of the second polarizer 422 described later. Further, the post-baking was carried out on a hot plate at 140° C. for 20 minutes to form a laminate illustrated in FIG. 5(b). As the first retardation layer 412, a λ/4 plate having a retardation of 137.5 nm at a wavelength of 550 nm was used.

Then, a SiO₂ film having a thickness of 100 nm was formed on the first retardation layer 412 by the sputtering method, and the dielectric layer 413 was provided to produce a laminate illustrated in FIG. 5(c).

Further, a rubbing alignment film was applied onto the dielectric layer 413 by spin coating at 2800 rpm for 12 seconds, thereby providing the first alignment film 414. Thereafter, the pre-baking was carried out at 60° C. for 90 seconds, and further the post-baking was carried out on a hot plate at 230° C. for 40 minutes. Subsequently, the rubbing treatment was performed on the first alignment film 414 at a press-in amount of 0.4 mm so that a rubbing direction 414a of the first alignment film 414 was parallel with the transmission axis 422a of the second polarizer 422, namely, the rubbing direction 414a of the first alignment film 414 and the in-plane slow axis 412a of the first retardation layer 412 formed an angle of 45°, thereby obtaining the first substrate 401 having a color filter layer illustrated in FIG. 5(d).

### <Production of Second Substrate Having Thin-Film Transistor in FFS Mode>

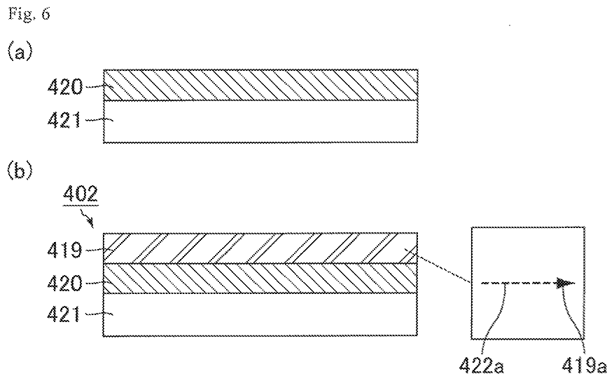

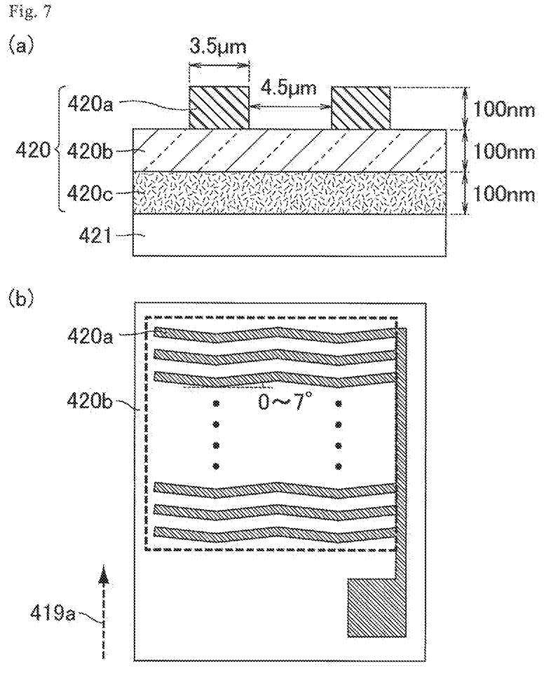

FIGS. 6(a) and 6(b) are views illustrating each step of producing a second substrate in Example 1, where FIG. 6(a) is a schematic cross-sectional view illustrating a state in which an electrode is provided on a base material, and FIG. 6(b) is a schematic cross-sectional view illustrating a state in which a second alignment film is provided on the electrode. FIGS. 7(a) and 7(b) are views illustrating a state of an electrode on a second substrate, where FIG. 7(a) is a schematic cross-sectional view of the electrode, and FIG. 7(b) is a schematic plan view of the electrode.

As illustrated in FIGS. 6(a) and 7(a), a pixel electrode 420c as a solid ITO electrode, an insulating film 420b made of SiN, and a common electrode 420a as a comb-like ITO electrode were provided in this order on the second base material 421 (a transparent base material having a thickness of 0.7 mm), followed by washing with ultrasonic wave and washing with pure water. Then, the electrode 420 in the FFS mode was arranged on the second base material 421. Here, the thicknesses of the common electrode 420a, the insulating film 420b, and the pixel electrode 420c were 100 nm, the width of the comb tooth portion of the comb-like common electrode 420a was 3.5 μm, and the interval between the comb tooth portions was 4.5 μm.

Subsequently, as illustrated in FIG. 6(b), a rubbing alignment film was applied to the electrode 420 by spin coating at 2800 rpm for 12 seconds, thereby providing the second alignment film 419. Thereafter, the pre-baking was carried out at 60° C. for 90 seconds, and further the post-baking was carried out on a hot plate at 230° C. for 40 minutes. Then, the rubbing treatment was performed on the second alignment film 419 at a press-in amount of 0.4 mm so that a rubbing direction 419a of the second alignment film 419 was parallel with the transmission axis 422a of the second polarizer 422, thereby obtaining the second substrate 402 having a thin-film transistor. Note that, as illustrated in FIG. 7(b), the rubbing direction 419a of the second alignment film 419 was arranged in a direction crossing the longitudinal direction of the comb tooth portion of the common electrode 420a.

### <Production of Liquid Crystal Element>

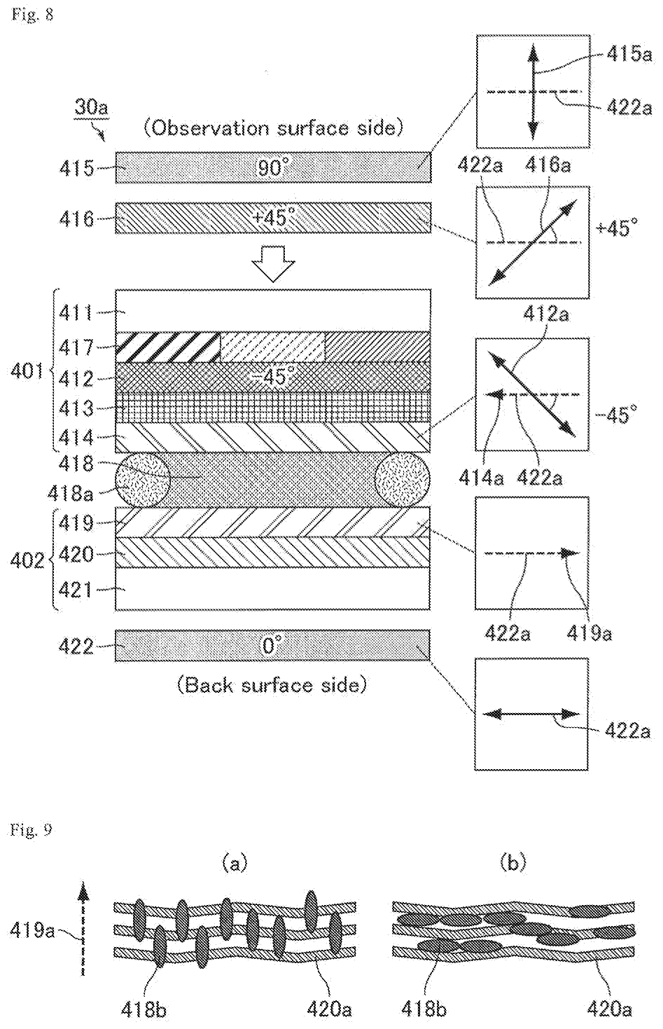

FIG. 8 is a schematic cross-sectional view illustrating a state of producing a liquid crystal element in Example 1. On the side of the first alignment film 414 of the first substrate 401 produced as described above, 3.5 μm spacers 418a were scattered, and an empty cell was produced by bonding the spacers 418a to the second substrate 402. At this time, the first substrate 401 was bonded to the second substrate 402 so that the rubbing direction 414a of the first alignment film 414 was parallel with and in an opposite direction from the rubbing direction 419a of the second alignment film layer 419.

Subsequently, negative liquid crystals were injected into the empty cell by differential pressure injection.

Further, the second retardation layer 416 was adhered to the surface, opposite to the color filter layer 417, of the first base material 411 in the first substrate 401 using a pressure-sensitive adhesive layer (not illustrated). Here, as the second retardation layer 416, a λ/4 plate having a retardation of 137.5 nm at a wavelength of 550 nm was used. Further, the second retardation layer 416 was bonded to the first base material 411 so that the in-plane slow axis 412a of the first retardation layer 412 was perpendicular to an in-plane slow axis 416a of the second retardation layer 416.

Subsequently, the first polarizer 415 and the second polarizer 422 were bonded so as to be arranged in a crossed Nicols state, thereby producing a liquid crystal element 30a. Here, the liquid crystal element 30a was arranged such that the rubbing direction 419a of the second alignment film 419 was parallel with the transmission axis 422a of the second polarizer 422, the rubbing direction 414a of the first alignment film 414 was parallel with the transmission axis 422a, the in-plane slow axis 412a of the first retardation layer 412 formed an angle of −45° with the transmission axis 422a, the in-plane slow axis 416a of the second retardation layer 416 formed an angle of 45° with the transmission axis 422a, and the transmission axis 415a of the first polarizer 415 formed an angle of 90° with the transmission axis 422a. The angle of −45° with the transmission axis 422a represents an angle obtained by rotating the transmission axis 422a clockwise by 45°, and the angle of 45° with the transmission axis 422a represents an angle obtained by rotating the transmission axis 422a counterclockwise by 45°.

The alignment state of the liquid crystal molecules in the liquid crystal layer 418 will be described. FIGS. 9(a) and 9(b) are views illustrating an alignment state of negative liquid crystal molecules of Example 1, where FIG. 9(a) is a schematic plan view illustrating a state of liquid crystal molecules in a no-voltage applied state, and FIG. 9(b) is a schematic plan view illustrating a state of liquid crystal molecules in a voltage-applied state. In a no-voltage applied state in which no voltage is applied between the common electrode 420a and the pixel electrode 420c (between the pair of electrodes) of the liquid crystal element 30a (hereinafter also simply referred to as “in a no-voltage applied state”), as illustrated in FIG. 9(a), liquid crystal molecules 418b are aligned in parallel with the rubbing direction 419a of the second alignment film. In a voltage-applied state in which a voltage is applied between the common electrode 420a and the pixel electrode 420c of the liquid crystal element 30a (hereinafter also simply referred to as “in a voltage-applied state”), as illustrated in FIG. 9(b), the liquid crystal molecules 418b as negative liquid crystals are aligned in parallel with the longitudinal direction of the comb tooth portion of the common electrode 420a.

### <Liquid Crystal Module>

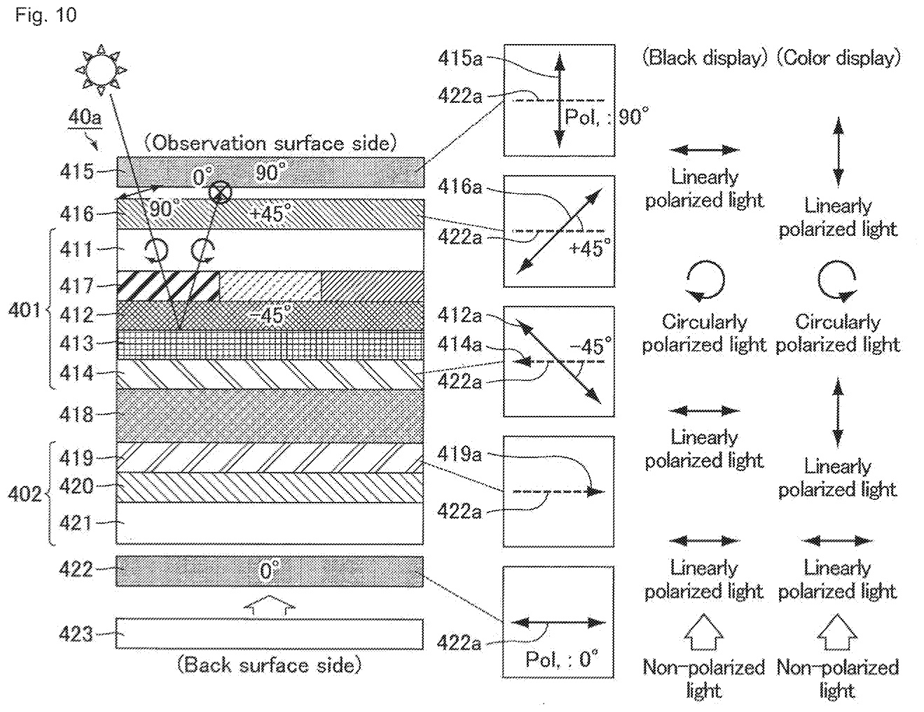

FIG. 10 is a schematic cross-sectional view of a liquid crystal module of Example 1 and a diagram illustrating a polarization state. A white light source as the backlight 423 was arranged at the side of the second polarizer 422 in the liquid crystal element 30a produced as described above, thereby producing a liquid crystal module 40a. As illustrated in the view of the polarization state in FIG. 10, the liquid crystal module 40a of Example 1 using the first retardation layer 412 has a low reflection function. In addition, switching between color display and black display works without problems. Details thereof will be described below.

The state of light in color display (in a voltage-applied state) will be described. The light in anon-polarization state, emitted from the backlight 423, passes through the second polarizer 422, whereby the light is converted to linearly polarized light parallel with the transmission axis 422a of the second polarizer and the light passes through the second substrate 402. The linearly polarized light having passed through the second substrate 402 passes through the liquid crystal layer 418, whereby the light is converted to linearly polarized light whose polarization state is different by 90 degrees. The linearly polarized light having passed through the liquid crystal layer 418 passes through the first retardation layer 412, whereby the light is converted to circularly polarized light. Further, the light passes through the second retardation layer 416, whereby the light is converted to linearly polarized light which forms an angle of 90 degrees with the transmission axis 422a of the second polarizer. Since the first polarizer 415 and the second polarizer 422 are arranged in a crossed Nicols state, the linearly polarized light having passed through the second retardation layer 416 is parallel with the transmission axis 415a of the first polarizer. The light passes through the first polarizer 415 and becomes visible on the observation surface side.

Subsequently, the state of light in the black display (in a no-voltage applied state) will be described. The light in a non-polarization state, emitted from the backlight 423, passes through the second polarizer 422, whereby the light is converted to linearly polarized light parallel with the transmission axis 422a of the second polarizer and the light passes through the second substrate 402 and the liquid crystal layer 418. The linearly polarized light having passed through the liquid crystal layer 418 passes through the first retardation layer 412, whereby the linearly polarized light is converted to counterclockwise circularly polarized light at the time of color display. Further, the light passes through the second retardation layer 416, whereby the light is converted to linearly polarized light parallel with the transmission axis 422a of the second polarizer. Since the first polarizer 415 and the second polarizer 422 are arranged in a crossed Nicols state, the linearly polarized light having passed through the second retardation layer 416 is absorbed by the first polarizer 415, and the display becomes black.

The in-plane slow axis 416a of the second retardation layer as the λ/4 plate and the transmission axis 415a of the first polarizer form an angle of 45°. Such a configuration realizes a configuration in which a circularly polarizing plate formed by stacking the first polarizer 415 and the second retardation layer 416 is arranged on the observation surface side. Therefore, the light incident from the observation surface side (the side of the first polarizer 415) is converted into circularly polarized light when passing through the circularly polarizing plate, and reaches the first substrate 401, whereby the reflection from the first substrate 401 is suppressed by the antireflection effect of the circularly polarizing plate.

In the liquid crystal module 40a of Example 1, the dielectric layer 413 was provided between the first retardation layer 412 and the first alignment film 414, whereby the solvent used for forming the first alignment film 414 did not dissolve the first retardation layer 412 even when the first alignment film 414 was arranged on the upper side of the first retardation layer 412. Thus, the first alignment film 414 could be easily formed.

Further, since the dielectric layer 413 is provided, deterioration of the retardation layer 412 due to dissolution can be suppressed. Thus, the depolarization performance can be maintained at a high level in the liquid crystal module 40a. Furthermore, the dielectric layer 413 also functions as a block layer for preventing ionic impurities in the retardation layer 412 and the color filter layer 417 from being dissolved in the liquid crystal layer 418, so that a high voltage holding ratio can be realized.

In the liquid crystal module 40a of Example 1, since the first retardation layer 412 is made of a photo-alignment material including a photo-reactive functional group, it is not necessary to use an adhesive layer, and a thin film (about 2 μm) can be formed.

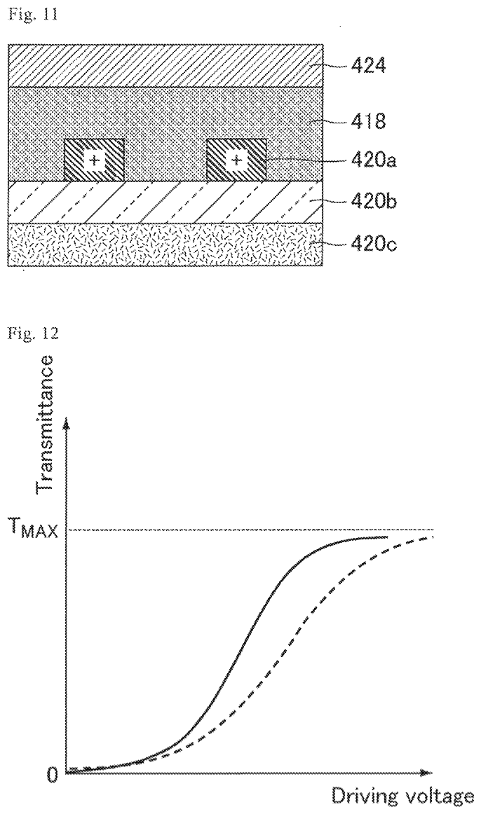

FIG. 11 is a schematic cross-sectional view of a liquid crystal element in a case where a conductive layer is used instead of a dielectric layer in the liquid crystal module of Example 1. FIG. 12 is a graph illustrating a relationship between driving voltage and transmittance, where a broken line is a graph concerning the liquid crystal module using the conductive layer, and a solid line is a graph concerning the liquid crystal module of Example 1 in which no conductive layer is used. As illustrated in FIGS. 11 and 12, it is difficult to lower the threshold value of the driving voltage when the conductive layer 424 is used. However, in the liquid crystal module 40a of Example 1 using the dielectric layer 413, the threshold value of the driving voltage can be lowered, and the width of the reduction in the transmittance can also be reduced.

### Example 2

### <Liquid Crystal Element Including Dielectric Layer Having Surface Directly Subjected to Rubbing Treatment>

The liquid crystal module of Example 2 has the same configuration as the liquid crystal module 40a of Example 1 except that the first alignment film is not used and the dielectric layer is directly subjected to the rubbing treatment.

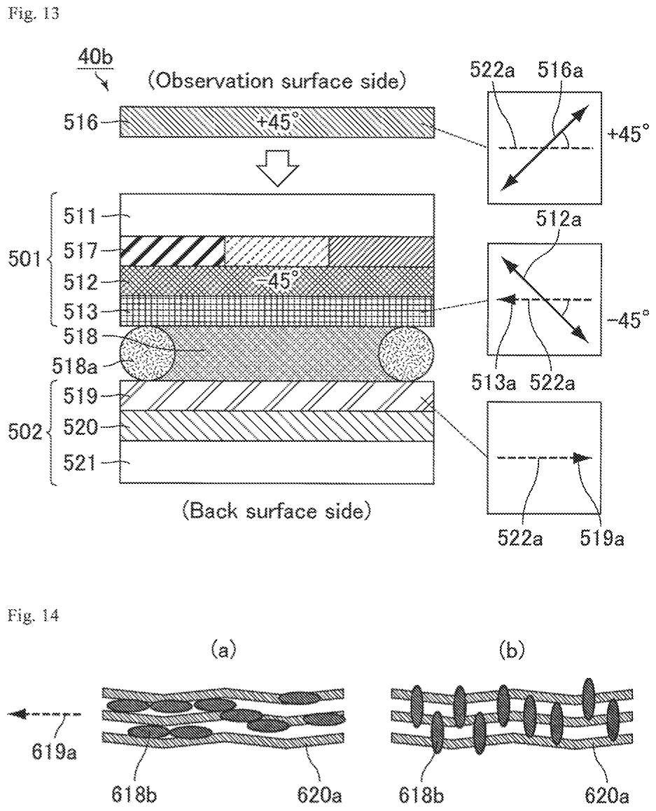

FIG. 13 is a schematic cross-sectional view illustrating a state of producing a liquid crystal module of Example 2. In the liquid crystal module 40a of Example 1, a rubbing alignment film was provided as the first alignment film 414 on the dielectric layer 413. However, in the liquid crystal module 40b of Example 2, the rubbing alignment film was not provided on the dielectric layer 513, and the dielectric layer 513 was directly subjected to the rubbing treatment. Also, in the liquid crystal module 40b of Example 2, the liquid crystal molecules are arranged in a rubbing direction 513a of the dielectric layer 513 subjected to the rubbing treatment so that the same operation as the liquid crystal module 40a of Example 1 can be performed.

The liquid crystal module 40b of Embodiment 2 includes a first polarizer (not illustrated), a second retardation layer 516, a first substrate 501, a liquid crystal layer 518, a second substrate 502, and a second polarizer, and a backlight (not illustrated), in this order from the observation surface side. The first substrate 501 has a first base material 511, a color filter layer 517, a first retardation layer 512, and a dielectric layer 513 in this order from the observation surface side, and the dielectric layer 513 is subjected to the rubbing alignment treatment. That is, the first substrate 501 is a substrate in which a color filter layer is provided between the base material 211 and the retardation layer 212 in the retardation substrate 20 of Embodiment 2.

The second substrate 502 has a second alignment film 519, an electrode 520, and a second base material 521, in this order from the observation surface side.

On the side of the dielectric layer 513 of the first substrate 501, 3.5 μm spacers 518a were scattered, and an empty cell was produced by bonding the spacers 518a to the second substrate 502. At this time, the first substrate 501 was bonded to the second substrate 502 so that the rubbing direction 513a of the dielectric layer 513 was parallel with and in an opposite direction from a rubbing direction 519a of a second alignment film layer 519.

Subsequently, negative liquid crystals were injected into the empty cell by differential pressure injection.

Further, the second retardation layer 516 was bonded to the surface, opposite to the color filter layer 517, of the first base material 511 in the first substrate 501 using a pressure-sensitive adhesive layer (not illustrated). Here, as the second retardation layer 516, a λ/4 plate having a retardation of 137.5 nm at a wavelength of 550 nm was used. Further, the second retardation layer 516 was bonded to the first base material 511 so that the in-plane slow axis 512a of the first retardation layer 512 was perpendicular to an in-plane slow axis 516a of the second retardation layer 516.

Subsequently, the first polarizer (not illustrated) and the second polarizer (not illustrated) were bonded so as to be arranged in a crossed Nicols state, thereby producing a liquid crystal element. Here, the liquid crystal element was arranged such that the rubbing direction 519a of the second alignment film 519 was parallel with the transmission axis 522a of the second polarizer, the rubbing direction 513a of the dielectric layer 513 was parallel with the transmission axis 522a, the in-plane slow axis 512a of the first retardation layer 512 formed an angle of −45° with the transmission axis 522a, the in-plane slow axis 516a of the second retardation layer 516 formed an angle of 45° with the transmission axis 522a, and the transmission axis of the first polarizer formed an angle of 90° with the transmission axis 522a of the second polarizer. The angle of −45° with the transmission axis 522a represents an angle obtained by rotating the transmission axis 522a clockwise by 45°, and the angle of 45° with the transmission axis 522a represents an angle obtained by rotating the transmission axis 522a counterclockwise by 45°.

In the liquid crystal module 40b of Example 2, it is not necessary to form an alignment film on the dielectric layer 513 provided on the first retardation layer 512, thereby causing no problem that the solvent used for forming the alignment film dissolves the first retardation layer 512. Therefore, similarly to the liquid crystal module 40a of Example 1, in the liquid crystal module 40b of Example 2, the depolarization performance can be maintained at a high level and to realize a high voltage holding ratio. Further, the dielectric layer 513 is subjected to the rubbing treatment in order to have a function as an alignment film, so that simplification of the production process and cost reduction can be realized.

### Example 3

### <Liquid Crystal Element Using Positive Liquid Crystal>

The liquid crystal module of Example 3 has the same configuration as the liquid crystal module 40a produced in Example 1 except that the liquid crystal molecules used for the liquid crystal layer are replaced with positive liquid crystals.

The alignment state of liquid crystal molecules in the liquid crystal layer of Example 3 will be described. FIGS. 14(a) and 14(b) are views illustrating an alignment state of positive liquid crystal molecules of Example 3, where FIG. 14(a) is a schematic plan view illustrating a state of liquid crystal molecules in a no-voltage applied state, and FIG. 14(b) is a schematic plan view illustrating a state of liquid crystal molecules in a voltage-applied state. In a no-voltage applied state, liquid crystal molecules 618b as positive liquid crystals are aligned in parallel with a rubbing direction 619a of the second alignment film as illustrated in FIG. 14(a).

Further, in a voltage-applied state, the liquid crystal molecules 618b are aligned perpendicularly to a longitudinal direction of a comb tooth portion of a common electrode 620a as illustrated in FIG. 14(b).

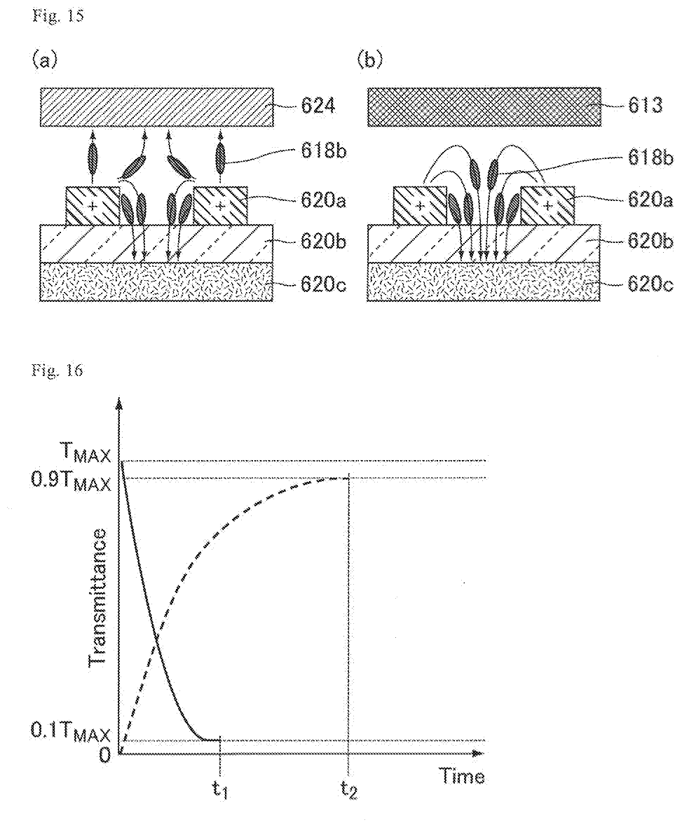

FIGS. 15(a) and 15(b) are views illustrating a state of liquid crystal molecules in a voltage-applied state, where FIG. 15(a) is a schematic cross-sectional view in a case where the conductive layer is used, and FIG. 15(b) is a schematic cross-sectional view in a case where the dielectric layer is used. As illustrated in FIG. 15(a), when the conductive layer 624 made of ITO was used instead of the dielectric layer in the liquid crystal module of Example 3, the electric field application was disturbed between the common electrode 620a and a pixel electrode 620c (a pair of electrodes) stacked with an insulating film 620b interposed therebetween, and the alignment state of the positive liquid crystal molecules was disturbed. Thus, when the conductive layer 624 was used, the positive liquid crystal molecules could not be used.

However, the dielectric layer 613 made of SiO₂ is used instead of the conductive layer 624 in the liquid crystal module of Example 3, whereby the electric field application between the common electrode 620a and the pixel electrode 620c is not disturbed, and the alignment state of the positive liquid crystal molecules is not disturbed. As a result, positive liquid crystal molecules can be used in Example 3 using the dielectric layer 613.

FIG. 16 is a graph illustrating a relationship between time and transmittance, where a broken line is a graph concerning negative liquid crystal molecules, and a solid line is a graph concerning positive liquid crystal molecules. In general, in the case of the negative liquid crystal molecules, it is difficult to synthesize a liquid crystal material with a low viscosity. Thus, as illustrated in FIG. 16, the response speed of the negative liquid crystal molecules is lower than that of the positive liquid crystal molecules. Therefore, when the positive liquid crystal molecules can be used instead of the negative liquid crystal molecules, the response speed can be improved. In the liquid crystal module of Example 3, even when the positive liquid crystal molecules are used, the alignment state of the liquid crystal molecules is not disturbed during application of a voltage. Accordingly, the function as the liquid crystal module can be achieved. Further, in the liquid crystal module of Example 3, since the dielectric layer 613 is arranged, the solvent used for forming the first alignment film is prevented from dissolving the first retardation layer. Thus, the first alignment film can be easily formed. Further, since the dielectric layer 613 is provided, deterioration of the retardation layer due to dissolution can be suppressed. Thus, the depolarization performance can be maintained at a high level. Further, the components of the retardation layer and the color filter layer are prevented from being dissolved in the liquid crystal layer, so that a high voltage holding ratio can be realized.

### Additional Remarks

One aspect of the present invention may include the retardation substrates 10, 301, and 401 including: the base materials 111, 311, and 411; the retardation layers 112, 312, and 412 provided on one surfaces of the base materials 111, 311, and 411; the dielectric layers 113, 313, 413, and 613 provided on the surfaces, opposite to the base materials 111, 311, and 411, of the retardation layers 112, 312, and 412; and the alignment films 114, 314, and 414 which are provided on the surfaces, opposite to the retardation layers 112, 312, and 412, of the dielectric layers 113, 413, and 613 and subjected to the liquid crystal alignment treatment.

When such an aspect is adopted, the dielectric layers 113, 313, 413, and 613 are present between the retardation layers 112, 312, and 412 and the alignment films 114, 314, and 414. Thus, the solvent used for forming the alignment films 114, 314, and 414 can be prevented from dissolving the retardation layers 112, 312, and 412. This makes it possible to provide the retardation substrates 10, 301, and 401 showing good depolarization performance and having a high voltage holding ratio when used for the liquid crystal element.

Another aspect of the present invention may include the retardation substrates 20 and 501 including: the base materials 211 and 511; the retardation layers 212 and 512 provided on one surfaces of the substrates 211 and 511; and the dielectric layers 213 and 513 which are provided on the surfaces, opposite to the base materials 211 and 511, of the retardation layers 212 and 512 and subjected to the liquid crystal alignment treatment.

In the retardation substrates 20 and 501 according to another embodiment of the present invention, since the alignment treatment is directly performed on the dielectric layers 213 and 513, the alignment film may not be used. This eliminates the problem that the solvent used for forming the alignment film dissolves the retardation layers 212 and 512. This makes it possible to provide a retardation substrate showing good depolarization performance and having a high voltage holding ratio when used for the liquid crystal element. Further, the production process for forming the alignment film can be omitted, and this leads to simplification of the production process and cost reduction.

The retardation layers 112, 212, 312, 412, and 512 may be made of a photo-alignment material including a photo-reactive functional group. Such an embodiment is adopted, so that the retardation layers 112, 212, 312, 412, and 512 having liquid crystal alignment properties in a single layer can be produced. Thus, in the liquid crystal display device having the retardation layers 112, 212, 312, 412, and 512, the parallax mixed color can be expected to be suppressed.

The retardation layers 112, 212, 312, 412, and 512 may include a liquid crystalline polymer. Such an embodiment is adopted, so that the retardation layers 112, 212, 312, 412, and 512 having liquid crystal alignment properties in a single layer can be produced. Thus, in the liquid crystal display device having the retardation layers 112, 212, 312, 412, and 512, the parallax mixed color can be expected to be suppressed.

The retardation layers 112, 212, 312, 412, and 512 may have a retardation of λ/4. Such an embodiment is adopted, so that the reflection of external light in the liquid crystal display device using the retardation substrates 10, 20, 301, 401, and 501 can be further suppressed.

The dielectric layers 113, 213, 313, 413, 513, and 613 may be inorganic films. Such an embodiment is adopted, so that the dielectric layers 113, 213, 313, 413, 513, and 613 can be easily formed by the dry process.

The inorganic films may contain at least one selected from SiO₂ and SiN.

The liquid crystal alignment treatment may be a rubbing alignment treatment. Such an embodiment is adopted, so that the alignment regulation force of liquid crystal molecules can be enhanced.

Another aspect of the present invention may include the liquid crystal elements 30 and 30a including: the retardation substrates 10, 20, 301, 401, and 501; the different base materials 321, 421, and 521; the liquid crystal layers 318, 418, and 518 provided between the retardation substrates 10, 20, 301, 401, and 501 and the different base materials 321, 421, and 521; and an electric field generator for generating an electric field in the liquid crystal layers 318, 418, and 518.

The electric field generator includes a pair of electrodes (the common electrodes 320a, 420a, and 620a and the pixel electrodes 320c, 420c, and 620c), and the pair of electrodes is provided on the different base materials 321, 421, and 521, and a lateral electric field may be generated in the liquid crystal layers 318, 418, and 518 by application of a voltage between the pair of electrodes.

The liquid crystal layers 318, 418, and 518 may contain liquid crystal molecules having positive anisotropy of dielectric constant. Such an aspect is adopted, so that the response speed can be further increased.

The liquid crystal elements 30 and 30a may further include the color filter layers 317, 417, and 517.

The liquid crystal elements 30 and 30a may further include a pair of polarizing plates (the first polarizers 315 and 415, and the second polarizers 322 and 422) arranged in a crossed Nicols state.

Another aspect of the present invention may include the liquid crystal modules 40, 40a, and 40b which include: the liquid crystal elements 30 and 30a; and a light source which irradiates the liquid crystal elements 30 and 30a with light.

### REFERENCE SIGNS LIST

10, 20: retardation substrate
30, 30a: liquid crystal element
40, 40a, 40b: liquid crystal module
111, 211: base material
112, 212: retardation layer
113, 213, 313, 413, 513, 613: dielectric layer
114: alignment film
301, 401, 501: first substrate (retardation substrate)
302, 402, 502: second substrate
311, 411, 511: first base material (base material)
312, 412, 512: first retardation layer (retardation layer)
314, 414: first alignment film (alignment film)
315, 415: first polarizer
316, 416, 516: second retardation layer
317, 417, 517: color filter layer
318, 418, 518: liquid crystal layer
319, 419, 519: second alignment film
320, 420, 520: electrode
320a, 420a, 620a: common electrode
320b, 420b, 620b: insulating film
320c, 420c, 620c: pixel electrode
321, 421, 521: second base material (different base material)
322, 422: second polarizer
412a, 512a: in-plane slow axis of the first retardation layer
414a: rubbing direction of the first alignment film
415a: transmission axis of the first polarizer
416a, 516a: in-plane slow axis of the second retardation layer
418a, 518a: spacer
418b, 618b: liquid crystal molecule
419a, 519a, 619a: rubbing direction of the second alignment film
422a, 522a: transmission axis of the second polarizer
423: backlight
424, 624: conductive layer
513a: rubbing direction of the dielectric layer

1. A retardation substrate comprising:
a base material;
a retardation layer provided on one surface of the base material;
a dielectric layer provided on a surface, opposite to the base material, of the retardation layer; and
an alignment film which is provided on a surface, opposite to the retardation layer, of the dielectric layer and subjected to a liquid crystal alignment treatment.

2. A retardation substrate comprising:
a base material;
a retardation layer provided on one surface of the base material; and
a dielectric layer which is provided on a surface, opposite to the base material, of the retardation layer and subjected to a liquid crystal alignment treatment.

3. The retardation substrate according to claim 1,
wherein the retardation layer is made of a photo-alignment material including a photo-reactive functional group.

4. The retardation substrate according to claim 1,
wherein the retardation layer contains a liquid crystalline polymer.

5. The retardation substrate according to claim 1,
wherein the retardation layer has a retardation of λ/4.

6. The retardation substrate according to claim 1,
wherein the dielectric layer is an inorganic film.

7. The retardation substrate according to claim 6,
wherein the inorganic film contains at least one selected from Sift and SiN.

8. The retardation substrate according to claim 1,
wherein the liquid crystal alignment treatment is a rubbing alignment treatment.

9. A liquid crystal element comprising:
the retardation substrate according to claim 1;
a different base material;
a liquid crystal layer provided between the retardation substrate and the different base material; and
an electric field generator which generates an electric field in the liquid crystal layer.

10. The liquid crystal element according to claim 9,
wherein the electric field generator includes a pair of electrodes,
the pair of electrodes is provided on the different base material, and
a lateral electric field is generated in the liquid crystal layer by application of a voltage between the pair of electrodes.

11. The liquid crystal element according to claim 9,
wherein the liquid crystal layer contains liquid crystal molecules having positive anisotropy of dielectric constant.

12. The liquid crystal element according to claim 9, further comprising a color filter layer.

13. The liquid crystal element according to claim 9, further comprising a pair of polarizing plates arranged in a crossed Nicols state.

14. A liquid crystal module comprising:
the liquid crystal element according to claim 9; and
a light source which irradiates the liquid crystal element with light.

15. The retardation substrate according to claim 2,
wherein the retardation layer is made of a photo-alignment material including a photo-reactive functional group.

16. The retardation substrate according to claim 2,
wherein the retardation layer contains a liquid crystalline polymer.

17. The retardation substrate according to claim 2,
wherein the retardation layer has a retardation of λ/4.

18. A liquid crystal element comprising:
the retardation substrate according to claim 2,
a different base material;
a liquid crystal layer provided between the retardation substrate and the different base material; and
an electric field generator which generates an electric field in the liquid crystal layer.

19. A liquid crystal module comprising:
the liquid crystal element according to claim 15; and
a light source which irradiates the liquid crystal element with light.
